(19) United States
(12) Patent Application Publication
(10) Pub. No.: US 2002/0129270 A1
(43) Pub. Date: Sep. 12, 2002

(54) Electronic device for providing software protection

(75) Inventors: Herbert Grieb, Malsch (DE); Peter Mueller, Eggenstein-Leopoldshafen (DE)

Correspondence Address: SUGHRUE MION, PLLC, 2100 PENNSYLVANIA AVENUE, N.W., WASHINGTON, DC, 20037, US

(73) Assignee: SIEMENS AG

(21) Appl. No.: 10/124,329

(22) Filed: Apr. 18, 2002

Related U.S. Application Data
(63) Continuation of application No. PCT/DE00/03649, filed on Oct. 17, 2000.

(30) Foreign Application Priority Data
Oct. 18, 1999 (DE) 199 50 249.8

(51) Int. Cl. G06F 11/30

(52) U.S. Cl. 713/200; 705/59

(57) ABSTRACT

An electronic device with software protection for runtime software. At least one function block (4-11) of the runtime software has a priority value. A maximum permissible value for the runtime software is retrievably stored in one device (12). An arithmetic logic unit (1) determines the total value for the function blocks of the runtime software and a display signal (14) is output if the total value exceeds the maximum permissible value. Function blocks and value blocks can have an OEM identification code, such that the system manufacturer and OEM can, independently of each other, create a software protection.

This is a Continuation of International Application PCT/DE00/03649, with an international filing date of Oct. 17, 2000, which was published under PCT Article 21(2) in German, and the disclosure of which is incorporated into this application by reference.

### FIELD OF THE INVENTION

The present invention relates generally to an electronic device for implementing software protection. More particularly, the invention relates to an electronic device comprising an arithmetic logic unit for processing a software program and a memory into which operating system software and runtime software is loaded. As a result of utilizing the electronic device, in accordance with the invention, software is protected form unauthorized use.

### BACKGROUND OF THE INVENTION

A prerequisite for successful marketing of software is to provide corresponding protection to prevent the use of the software by multiple users when no corresponding license for the software was acquired. For this reason technical means are required to protect the software against unlicensed use. Particularly in automation devices, for which a control program is created by interconnecting different function blocks, protection is necessary to prevent the unlicensed multiple use of the function blocks. This should not be a copy protection, which is typically used for many software products for personal computers. Protection against unlicensed multiple use means that software runs on an automation device only if the user has acquired the corresponding right, e.g., if the manufacturer has granted a license.

According to one conventional method of software protection, protection against unlicensed multiple use of software is coupled to a unique identification code of the electronic device, e.g. a serial number. The software is designed in such a way that it runs only on the target system for which it was released. Restricting use to target systems in this manner, however, has the drawback that the protection is not applicable at all legitimate potential use locations because not all target systems currently have serial numbers. Furthermore, due to coupling the protection to a single target system, it is difficult to switch to another target system with the same configuration, for example if the original target system fails.

Another conventional option for protecting against unlicensed multiple use is to employ a unique identification code for the target system, e.g. a serial number, to monitor in the engineering system the loading of protected software into a target system. For similar reasons to those mentioned above, this option is also not ideal because target systems do not usually have a serial number and switching to another target system with the same configuration would be difficult if the original target system fails. The effectiveness of the protection mechanism would in this case be limited to an engineering system. Accordingly, additional measures for software copy protection would be required in the engineering system.

Alternatively, the protected software could be linked to name declarations, e.g. a project name. In accordance with this method, the engineering system is required to check whether the protected software should be used in various projects and has to inhibit its use where applicable. Without further additions, however, this measure is not sufficient, since software can in principle be duplicated outside the engineering system as well. A secure protection function would thus not be provided.

A further option could be to use a copy protection program comparable to “StopCopy” (BBI Computer Systems, Inc. of Silver Spring, Maryland) to prevent the protected runtime software from being reproduced. Such a copy protection program would have to be effective in the areas of engineering systems and target systems. This type of copy protection, however, has been met with problems of acceptance on the part of system manufacturers as well as users because it is difficult to handle, particularly if a license is lost. In addition, the protection mechanism has to be implemented in the software of the engineering system and in all the components of the target system.

### OBJECTS OF THE INVENTION

In view of the above-described problems with conventional software copy protection systems, one object of the present invention is to define an electronic device equipped with effective protection against unlicensed multiple use of its resident software and which is distinguished by ease of handling of the software for both manufacturers and users.

### SUMMARY OF THE INVENTION

To attain the above and other objects of the invention, a novel electronic device in accordance with the present invention includes an arithmetic logic unit operable to process a software program, a first memory into which operating system software is loaded, a second memory into which runtime software with at least one function block is loaded, a storage mechanism operable to retrievably store a maximum permissible value for the runtime software and a determining means for determining a total value of the function blocks of the runtime software. The determining means also generates an error signal if the total value of the function blocks exceeds the maximum permissible value. Further, the at least one function block is provided with a value representing a value of a license corresponding to the runtime software.

A device in accordance with the present invention advantageously protects runtime software which is loaded into a target system and which runs on the target system. The term “function blocks of the runtime software” denotes system function blocks, standard function blocks, user function blocks, function blocks generated by means of a graphic design tool, which is also referred to as a continuous function chart, loadable drivers, operating system add-ons, or other optional software modules that can be loaded into an arithmetic logic unit.

In general, a distinction can be drawn between two kinds of software protection: technological protection on the one hand and protection against unlicensed multiple use on the other hand. Technological protection prevents the user from reading or accessing the source code of the software. This measure protects the manufacturer's technological or software “know-how”. In the SIMATIC S7 automation systems of Siemens AG for instance, technological protection is implemented by the KNOWHOW-Protect attribute. This makes the technological functions, which are implemented by software function blocks, inaccessible to the user. In this connection, the term “runtime software” refers to any type of software program that can be loaded into and executed in a target system. This can, for instance, include system function blocks, function blocks for technological functions, and operating system function blocks.

A license permits the user to use the software on a target system, for example, on an automation device. Within the target system, the software can be used as often as desired. In other words, the license refers to the use of the block type rather than to the block instance, which is realized with the block within the runtime software. The software is protected in accordance with a value defined for it. The system checks whether the entire protected software program used in a target system is covered by the maximum value stored in an electronic device. The runtime software can be used in the target system only within the scope of the granted license. Use of the software is possible only if a corresponding counter value for the protected software is stored in the device.

With respect to sale and support of the software, the additional complexity involved for the system manufacturer for handling protected software is minimal compared to the handling of unprotected software. Protected software can be marketed in different ways, e.g. by diskette, CD, memory card, or through the Internet. For a user, the handling of protected software requires at most minor changes compared to the handling of unprotected software. In addition, protected and unprotected software can be handled and operated together.

The cost of support by the software manufacturer is positively influenced by the fact that no interaction via a hotline between user and manufacturer is required unless there is a problem with the operation of the device. For instance, no registration or authorization numbers need to be requested to operate the software. If the value stored in the electronic device is not sufficient to operate the runtime software, the system provides the user with clear instructions on how to proceed. Different versions of the operating system of the electronic device, e.g. in case of updates or upgrades, do not affect the use of protected software. No new protection mechanisms have to be added to handle the newer versions.

In accordance with the invention, software protection is not linked to the individual software component but to the component's corresponding value. This substantially simplifies software protection procedures for the system manufacturer and the user and makes handling of the software more flexible. For instance, protected software components can be readily exchanged or supplemented as long as the value of the license is sufficient.

Advantageously, software protection in accordance with the invention does not require a fixed assignment between a hardware component, which is frequently referred to as a “dongle”, and specific protected software. This substantially simplifies handling for the user, since it does not require different dongles for different software components, and the protected software can run on more than a single target system.

Furthermore, the protection mechanism according to the invention is operative only while the protected software is running. Prior to being used on a target system, the protected software can be handled similar to unprotected software and can , for example, be copied as often as desired. Thus, the problems associated with conventional copy protection programs are avoided. Furthermore, the value corresponding to the scope of protection can be directly and flexibly associated with a price.

In accordance with one embodiment of the invention the maximum permissible value for the runtime software is retrievably stored in a hardware module. The hardware module which can be installed in, or connected to an electronic device that runs the protected software and, has the advantage that the value can be readily adapted in the event there are software changes. In addition, software protection can be realized without costly intervention in the hardware of the subject electronic device. If the user uses protected software, he will not require any other components in addition to the existing system components—except for the easily replaceable hardware module. With respect to replacing individual components of the electronic device, there is no difference between protected and unprotected software. In particular, the current software can continue to be used without any changes even when individual components of the subject electronic device are replaced.

According to a further embodiment, the use of a memory card as the hardware module has the advantage, particularly in automation devices, that no additional hardware components are required for the system since a memory card is typically used in most electronic devices anyway. No complex hardware intervention is necessary because the memory card can simply be inserted into the slot already provided for it. The reliability of a memory card is adequate for the protection function according to the invention and a copy of the contents of the memory card, with an equally valid value, cannot typically be easily made.

According to a further embodiment, the mechanism in which the maximum permissible value for the runtime software is retrievably stored has a unique identification code, for example, a serial number, and the stored value can be configured as a loadable value block, which is valid only for the mechanism with the corresponding identification code. This makes it easy to increase the value of a license by loading another value block with the required value into the mechanism.

Marketing of the value blocks can be automated, e.g. via the Internet. No hardware components need to be handled for this purpose. This avoids so-called value orphans. The term “value orphan” refers to a mechanism which permanently stores a maximum permissible value that is no longer adequate for a concrete application, e.g. because the application has meanwhile been supplemented by additional protected software components. Since increasing the value without reloadable value blocks would either be completely impossible or could be performed only by the manufacturer of the mechanism, such a mechanism would then become useless for the user. In accordance with this embodiment, value blocks can be seamlessly integrated in the existing software environment of automation devices, since they are function blocks in principle.

Dividing the function blocks into groups, particularly by manufacturers with correspondingly associated value blocks, has the advantage that function blocks of different manufacturers can be protected by a single mechanism in which the maximum permissible values are stored. In accordance with reloadable value blocks, Original Equipment Manufacturers (OEMs), i.e. users who themselves design and market software, can protect their software independent of, and without the direct support by the manufacturer of the electronic device. The value can be directly and locally issued or increased at the user site, independently of the hardware of the system manufacturer or the OEM. It is not necessary, for instance, to ship a new memory card on which the new maximum permissible value is stored because a data link is sufficient to store a new value.

### BRIEF DESCRIPTION OF THE DRAWINGS

The invention and embodiments and advantages thereof will now be described in greater detail with reference to an example depicted in the drawings in which

FIG. 1 is a block diagram of an electronic device with software protection in accordance with the present invention,

FIG. 2 is a block diagram of a mechanism in accordance with the present invention in which values are stored,

FIG. 3 depicts a mechanism in accordance with the present invention for storing values and function blocks illustrating the principle of action,

FIG. 4 is an input mask in accordance with the present invention for generating a value block,

FIGS. 5 and 6 are flow diagrams illustrating a verification process in accordance with the present invention verifying that the license is adequate.

### DETAILED DESCRIPTION OF THE PREFERRED EMBODIMENTS

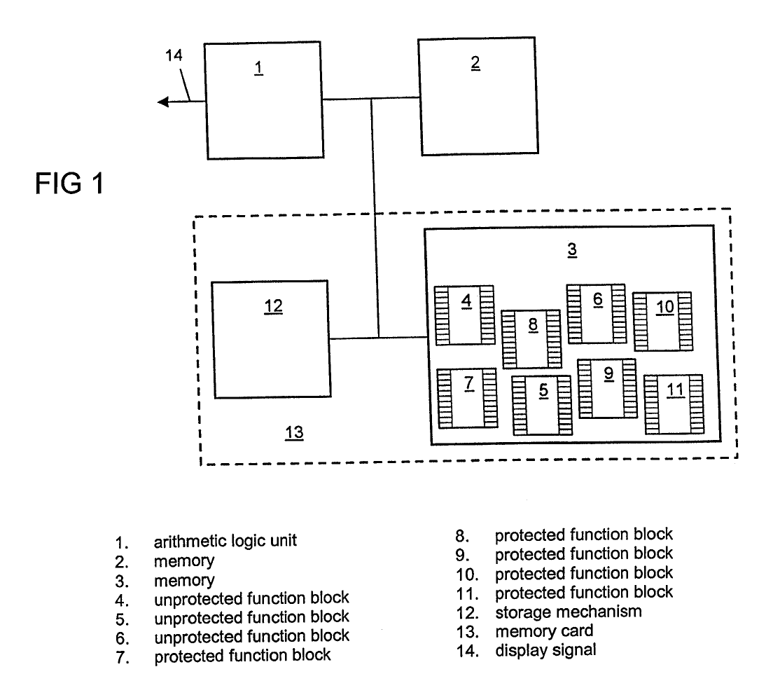

According to FIG. 1, an electronic device is equipped with an arithmetic logic unit 1, which uses operating system software located in memory 2 to process runtime software in a memory 3. The runtime software is application-specific and, e.g. in automation devices, is adapted to the respective control function of the application. In the exemplary embodiment illustrated, the runtime software comprises a total of eight function blocks 4 through 11. Function blocks 4, 5 and 6 are unprotected and therefore do not have an associated value. In contrast, function blocks 7 through 11 are protected, and each is provided with a value, which represents the value of the license. Each protected function block is thus associated with a value. A user who wishes to use the protected function blocks acquires a license with a defined value. This license is reflected by a maximum permissible value for the runtime software, which is retrievably stored in a mechanism 12.

The user uses protected software corresponding to protected function blocks as long as the total value of the protected software is covered by the value of the license. The maximum permissible value, along with the runtime software, is stored on memory card 3. As an alternative to the depicted example, the memory for the operating system software can also be arranged on memory card 13. The arithmetic logic unit 1 uses the operating system software in memory 2 to check whether the total value of all protected function blocks, i.e. of function blocks 7 through 11, exceeds the maximum permissible value stored in mechanism 12. If so, a protection violation exists and a display signal 14 is output, which causes a predefined response.

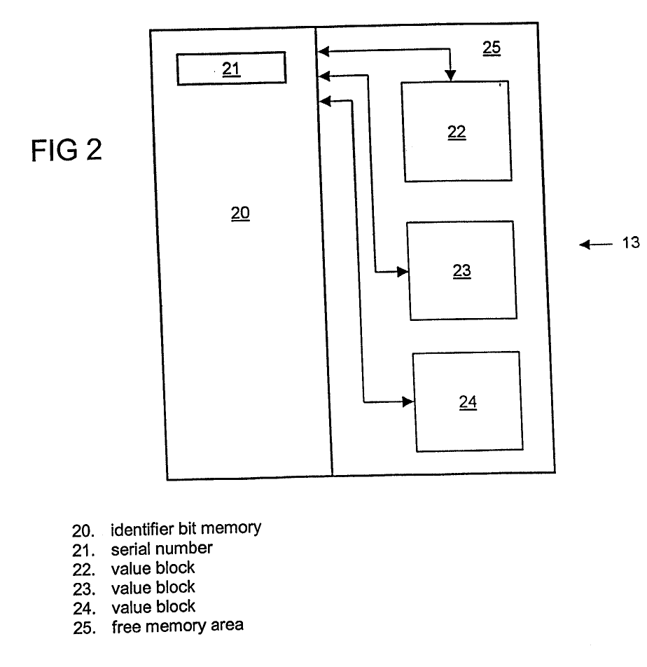

FIG. 2 shows an example of memory card 13 for implementing mechanism 12 with reloadable value blocks. In an identifier bit memory 20 of memory card 13, a serial number 21 is stored in a memory cell. Serial number 21 can be described only by the manufacturer of memory card 13 and not by the user. Serial number 21 uniquely identifies memory card 13. Value blocks 22, 23 and 24 are manufacturer-specific and are stored in a free memory area 25 of memory card 13. Value block 22 is provided for the manufacturer of the electronic device, and value blocks 23 and 24 are provided for a first OEM and a second OEM, respectively. The manufacturer and the OEM can thus produce their own value blocks and can issue their own licenses to the user. The free area 25 of memory card 13 also stores the runtime software, which is not depicted in FIG. 2 for the sake of clarity. With respect to their software structure, value blocks are identical to function blocks and can therefore be handled like function blocks; value blocks do not have an executable program code, however. Value blocks 22, 23, and 24 are valid only in conjunction with a defined serial number 21.

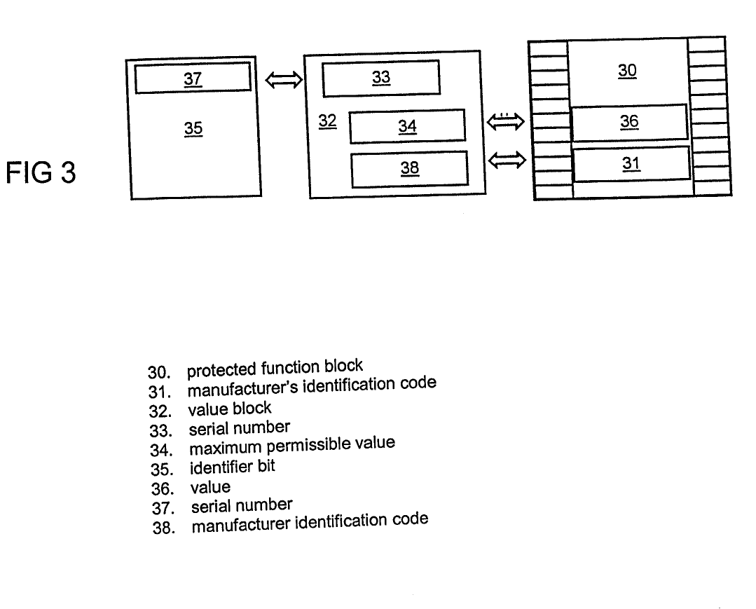

The interdependencies between serial number, value blocks, and protected function blocks are illustrated in FIG. 3. For instance, a protected function block 30 comprises a manufacturer identification code 31 consisting of a readable manufacturer name and a password that is hidden from the user. Manufacturer identification code 31 must match manufacturer identification code 38 in a value block 32, so that value block 32 can be uniquely assigned to the manufacturer of function block 30. A serial number 33 and a maximum permissible value 34, which are again inaccessible to the user, are stored in value block 32. The uniqueness of value block 32 is ensured via serial number 33 and guarantees that value block 32 is valid only for the mechanism with corresponding serial number 37, which is stored in an identifier bit 35, wherein serial number 37 matches serial number 33 of value block 32. Verification that serial numbers 33 and 37 match prevents multiple use of the value blocks. Furthermore, a value 36, i.e. a value of function block 30, is stored in function block 30 in a non-editable form for the user. For the license to be sufficient, the total value of all protected function blocks of a manufacturer must be covered by value 34 in value block 32 of the corresponding manufacturer.

The data corresponding to the function blocks and the value blocks does not need to be encoded if the contents of the value blocks and the protected function blocks cannot be read by the user. For instance, in SIMATIC S7 this is adequately ensured by setting the attribute KNOWHOW-Protect. However, if for some reason this protection is not adequate to prevent unauthorized access, the data must be encoded.

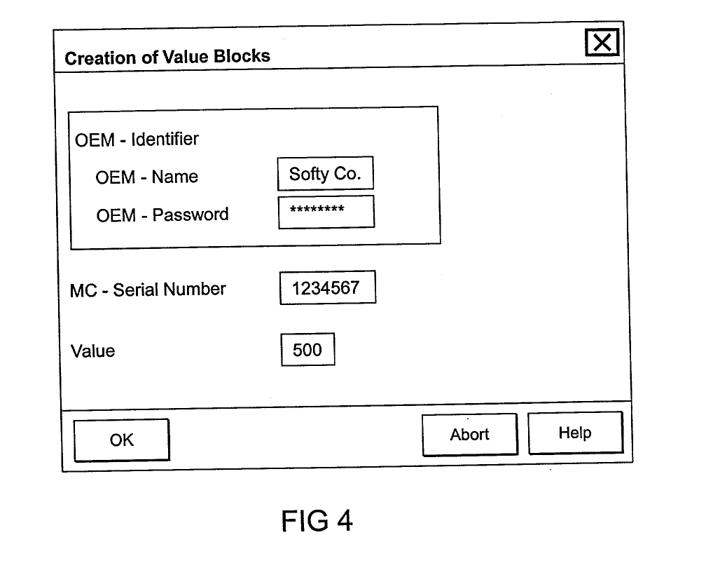

FIG. 4 shows the user interface of a tool for generating value blocks. The manufacturer identification code, which in FIG. 4 is described as an OEM identification code, can be freely selected by the OEM and comprises two parts. The visible part is the OEM name, in this case Softy Company, which the user can read at any time to determine from which manufacturer a value block or protected software originates. The second part is an OEM password, which is known only to the respective OEM and remains hidden from the users. This prevents any misuse because only the OEM, who knows the password, is able to generate value blocks. Furthermore, a serial number of the memory card, in this case identified as MC serial number, and a value of the value block can be entered in the input mask depicted in FIG. 4.

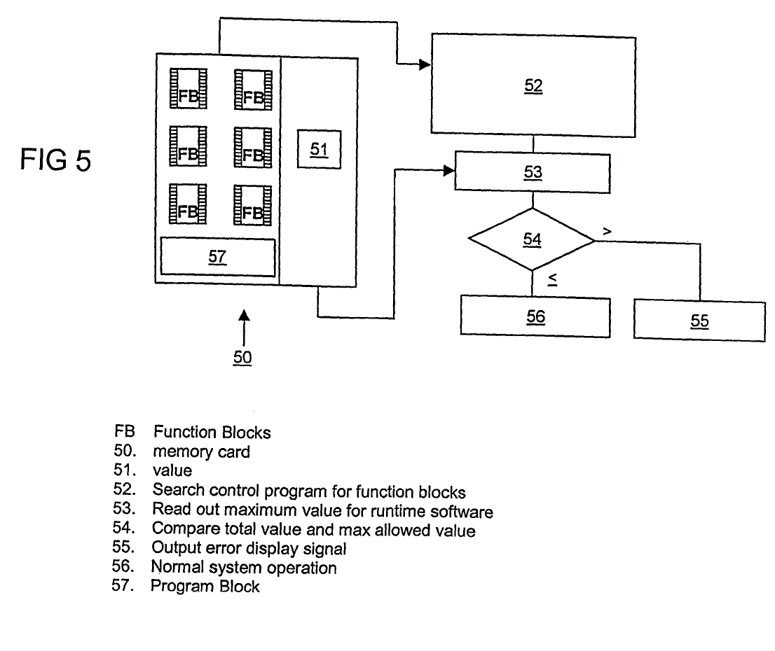

According to FIG. 5, the sufficiency of the license can be checked each time an electronic device is powered-up, as the software is loaded, or at suitable intervals during operation. Function blocks FB and a value 51 are stored on a memory card 50. To check the license, the arithmetic logic unit uses suitable operating system software in a step 52 to search the control program for function blocks FB, to read out the individual values, and to calculate the total value. In a step 53, the maximum permissible value 51 for the runtime software is read out. This is followed by a comparison 54 between the total value determined in step 52 and the maximum permissible value 51. If the total value exceeds the maximum permissible value 51, a display signal is output in a step 55 and other error responses may occur. Otherwise, the system switches to normal operation in a step 56. All protected function blocks located on memory card 50 can be included in the process shown in FIG. 5. Verification is independent of whether an instance of a function block type is installed in a run cycle. Program block 57 represents the corresponding interconnection of the function blocks in FIG. 5. The described verification is performed separately for each manufacturer.

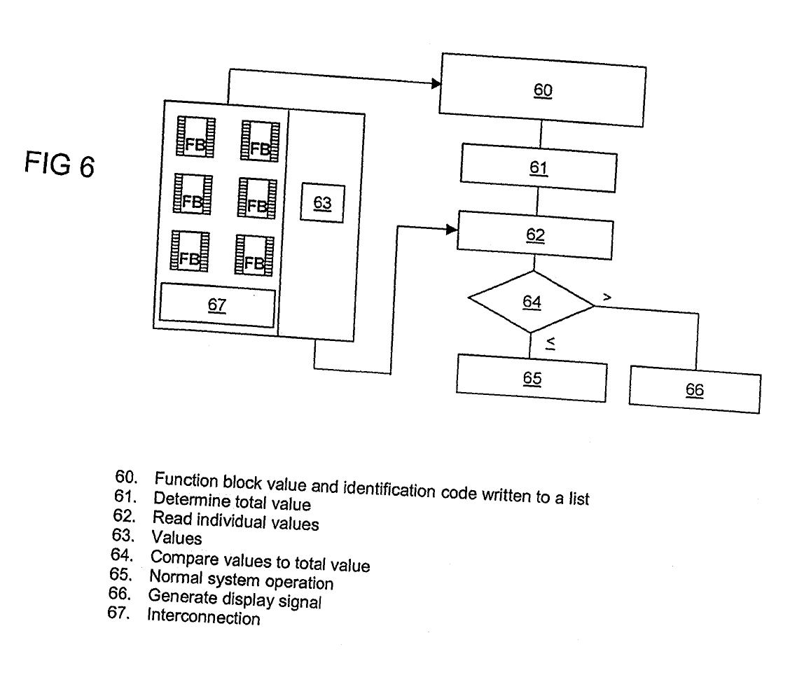

Another option for verifying the values in accordance with a further embodiment of the invention will now be described with reference to the sequence shown in FIG. 6. Each time an instance realized by a function block is initially called, the function blocks FB write their respective value and the manufacturer identification code into a list of the operating system. This process corresponds to a step 60 of the sequence shown. After the complete application program has been run through once, it can be assumed that the list comprises the values and the manufacturer identification code for all function blocks involved. In step 61, this list is analyzed by adding the separate values of the respective manufacturer identification codes to obtain a total value. In step 62, values 63 are read from the value blocks and in a comparison step 64 the values are again compared with the calculated total value. If the license is sufficient, the system switches to normal operation 65, if the license is not sufficient, however, a display signal is output in a step 66 and a response is initiated. In this type of verification, only the function blocks FB that are installed in the sequence of the runtime software according to an interconnection 67 are recorded.

For the variants described with reference to the embodiments of FIGS. 5 and 6, verification is preferably executed when the arithmetic logic unit of the electronic device is started up. In arithmetic logic units that allow the mechanism with the stored maximum permissible values to be removed during operation without interruption, this verification should, in addition, be performed at suitable time intervals.

Depending on the particular application, different responses to an inadequate license are possible. For instance, in addition to showing a display signal, the arithmetic logic unit can continue to operate at a reduced capacity. A more serious consequence could be that the arithmetic logic unit, if the license is inadequate, enters a stop status, so that the electronic device is no longer operable.

To simplify handling of the software protection during configuration, testing, startup, or hardware failure, the user of the electronic device, may be offered a number of aids. One aid consists of giving the user a generally valid memory card, whose value blocks contain the value μ. With this memory card, all protected components are processable without restriction. Another aid consists of switching the arithmetic logic unit of the electronic device to a “test” mode via parameterization on an engineering system. In this mode, the values are not checked. All protected function blocks can again be fully processed. After a defined time, e.g. after 200 hours, this test operation expires and the described protection mechanisms become effective again.

The value blocks can be sold, for instance, through mail order. For example, the user can order a value block with a defined value either in writing or by telephone from the manufacturer whose function block library he is using, by giving the serial number of the memory card. The manufacturer can, for instance, be the manufacturer of the electronic device or an OEM. This manufacturer produces the value component, puts it on a diskette, and ships it to the customer against invoice.

The Internet offers another, fully automated, option of marketing. For example, the user can visit the service homepage of the manufacturer, which includes a menu item called “order value components.” Here, the user enters his or her name and e-mail address, the serial number of the memory card, the desired value, and the preferred method of payment, e.g. invoice or credit card, and then processes the order. A server of the manufacturer can use this information to generate a value block automatically and send it to the customer by e-mail.

As an alternative to this embodiment, a dongle, which in this case is embodied as a memory card, can be implemented as a hardware key, which is installed in the plug of an MPI connection cable or is plugged into the MPI interface as a dummy plug if no MPI connection is used. This implementation variant, however, requires a new dongle, i.e., an additional hardware component, to be developed. The dongle would moreover have to be adapted to future further developments of the MPI interface.

As an alternative to reloadable value blocks, a total value can be stored in the identifier bit memory of the memory card, which consequently cannot be changed by software. This total value covers the value of all protected software of system manufacturers and OEMs. The memory cards are produced with different values and because they are different products they are also given different order numbers. In other words, for N different values, N different types of memory cards must be maintained as products and each memory card must be kept in inventory. In this variant, no distinction can be drawn between system manufacturer and OEM, because only one total value is stored for both. Since this value cannot subsequently be changed, the aforementioned “value orphans” are created.

A further variant is created by storing fixed total values separately for system manufacturer and OEM in the identifier bit memory of the memory card. This makes it possible to distinguish between the software of the system manufacturer and the OEM for software protection. The memory cards are produced with different values, and each value combination corresponds to an independent product with its order number. The number of products that have to be kept in inventory is multiplied accordingly. In addition, the OEM identification code can be assigned to the corresponding values.

As a further alternative, a memory card is created whose identifier bit memory includes an area into which user data can be written. This area, however, is accessible only if the associated programming mechanism is known. In this area, the value and the OEM identification code are stored. An OEM in this case requires a special programming tool with the programming mechanism to access this area of the identifier bit memory. This programming tool can be implemented as an expansion of an engineering system provided by the manufacturer of the memory card. In this variant, OEMs can themselves change the value and their identification code. As a result, fewer products have to be kept in inventory and protection is connected with lower costs.

In deviation from the described exemplary embodiments, value blocks can be loaded into memory 2 or 3 (FIG. 1) of the electronic device, so that the memory area of mechanism 12 in which a maximum permissible value for the runtime software is retrievably stored, is replaced by a portion of memory 2 or 3. In this case, mechanism 12 has a unique identification code, e.g. a serial number, and is preferably configured as a replaceable hardware module.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. An electronic device operable to provide software protection, the device comprising:
an arithmetic logic unit operable to process a software program;
a first memory into which operating system software for said arithmetic logic unit is loaded;
a second memory into which a runtime software comprising at least one function block is loaded, wherein the at least one function block is provided with a value representing a value of a license, corresponding to the runtime software;
a storage mechanism operable to retrievably store a maximum permissible value for the runtime software; and
determining means for determining a total value for the function block(s) of the runtime software and for generating an error signal if the total value for the function block(s) exceeds the maximum permissible value.

2. An electronic device as claimed in claim 1, wherein the storage mechanism is configured as a hardware module that is either installed in, or connected to, the electronic device.

3. An electronic device as claimed in claim 2, wherein the hardware module is a memory card.

4. An electronic device as claimed in claim 2, wherein the storage mechanism has a unique identification code and wherein further, the stored value is configured as a loadable value block which is valid only for a device which has the respective identification code.

5. An electronic device as claimed in claim 4, where the unique identification code is a serial number.

6. An electronic device as claimed in claim 4, wherein the function block(s) are divided into groups, each group being assigned a value block, and means are provided for determining a total value for the function block(s) of a particular group and for generating a group error signal if the total value for the function block(s) exceeds the maximum permissible value.

7. An electronic device as claimed in claim 6, wherein the function block(s) are divided into groups according to manufacturer.

8. A hardware module operable to be either installed, or connected to an electronic device, wherein a maximum permissible value for run time software or a unique identification code is stored in the hardware module so as to be retrievable by the electronic device.

9. A hardware module as claimed in claim 8, wherein the module is a memory card.

10. A hardware module as claimed in claim 8, wherein the unique identification code is a serial number.

11. A hardware module as claimed in claim 8, wherein the maximum permissible value corresponds to a maximum permissible license scope associated with the runtime software, wherein further the runtime software is loaded in the hardware module.

12. An electronic device as claimed in claim 1, wherein one or more of the at least one function blocks has a corresponding value.

13. An electronic device as claimed in claim 12, wherein the corresponding value represents a scope of a license associated with the corresponding function block.

14. A method for protecting runtime software in an electronic device, the method comprising:
storing at least one function block associated with the runtime software;
storing at least one license value, each stored license value being associated respectively with one of the at least one function block(s);
determining a total value by summing the at least one license value(s);
comparing the total value with a required value, wherein the required value represents a minimum license requirement for operation of the runtime software;
permitting operation of the runtime software according to a result of said comparison.

15. A method as claimed in claim 14, further comprising generating an error signal if the required value exceeds the total value.

16. A method as claimed in claim 14, further comprising loading a test value into the electronic device, wherein the test value exceeds the required value.

17. A method as claimed in claim 14, further comprising modifying the license value in accordance with a license agreement.
